(19) United States
(12) Patent Application Publication
(10) Pub. No.: US 2017/0041976 A1
(43) Pub. Date: Feb. 9, 2017

(54) Systems and Methods for Maintaining Data Communications on a Multi-Subscriber Identity Module (SIM) Wireless Communication Device

(71) Applicant: QUALCOMM Incorporated, San Diego, CA (US)

(72) Inventors: Hieu Trung Van, Kingston Upon Thames (GB); Abeezar Burhan, lckenham (GB); Simon Walke, Basingstoke (GB); Raghav Agarwal, Farnborough (GB)

(21) Appl. No.: 14/820,985

(22) Filed: Aug. 7, 2015

(51) Int. Cl. H04W 76/02; H04M 15/00; H04L 1/16; H04W 48/18

(52) U.S. Cl. CPC H04W 76/027; H04W 48/18; H04M 15/7556; H04L 1/16; H04W 88/06

(57) ABSTRACT

In a multi-subscription wireless communication device with a shared radio frequency (RF) resource supports an active data communication on a first network of a first SIM by performing tune-aways to support a subscription on a second SIM. After a tune-away of the shared RF to the second network, the wireless communication device may identify scheduled packet downlink acknowledgment/non-acknowledgment (ACK/NACK) message transmissions on the modem stack associated with the first SIM. The wireless communication device may determine whether a next scheduled packet downlink ACK/NACK (PDAN) message transmission to the first network is missed, and if so, increment a PDAN failure counter on the modem stack associated with the first SIM. If the value of the PDAN failure counter on the modem stack associated with the first SIM is equal to a preset threshold, the wireless communication device may force the shared RF resource to tune back to the first network.

### BACKGROUND

Multi-subscriber identity module (SIM) wireless communication devices have become increasing popular because of their flexibility in service options and other features. One type of multi-SIM wireless communication device, a multi-SIM multi-standby (MSMS) device (e.g., a dual-SIM dual-standby (DSDS) device), enables two SIMs to be in idle mode waiting to begin communications, but only allows one SIM at a time to participate in an active communication due to sharing of a single radio frequency (RF) resource (e.g., a transceiver). Other multi-SIM devices may extend this capability to more than two SIMs and may be configured with any number of SIMs greater than two (i.e., multi-SIM multi-standby wireless communication devices).

Wireless communication networks (referred to simply as “wireless networks”) are widely deployed to provide various communication services such as voice, packet data, broadcast, messaging, and so on. Wireless networks may be capable of supporting communication for multiple users by sharing the available network resources. Such sharing of available network resources may be implemented by networks using one or more multiple-access wireless communications protocols, such as Time Division Multiple Access (TDMA), Code Division Multiple Access (CDMA), Time Division Multiple Access (TDMA), and Frequency Division Multiple Access (FDMA). These wireless networks may also utilize various radio technologies, including but not limited to Global System for Mobile Communications (GSM), Universal Mobile Telecommunications System (UMTS), CDMA2000, Advanced Mobile Phone Service (AMPS), General Packet Radio Services (GPRS), Long Term Evolution (LTE), High Data Rate (HDR) technology (e.g., 1×EV technology), etc.

Since an MSMS wireless communication device typically uses a single RF resource to communicate over the multiple SIMs and/or networks, the device actively communicates using a single SIM and/or network at a given time. As such, with an active data communication on one SIM (e.g., the first SIM), the wireless communication device may periodically tune away to a network associated with another SIM (e.g., the second SIM) to monitor signals or acquire a connection. As a result, the wireless communication device may be unable to send or receive control signals that are normally exchanged with the network supported by the first SIM to maintain the active data communication. As a result, the data link on the first SIM may time out (i.e., be dropped by the network) after a certain number of failed control signals, which may degrade throughput of the data communication on the first SIM.

### SUMMARY

Systems, methods, and devices of various embodiments may enable a wireless communication device configured to use at least a first SIM and a second SIM associated with a shared radio frequency (RF) resource to improve data throughput. Various embodiments may include detecting an active data communication in a first network on a modem stack associated with the first SIM, detecting a tune-away of the shared RF resource from the first network to a second network supported by the second SIM, identifying scheduled packet downlink acknowledgment/negative acknowledgment (ACK/NACK) message transmissions on the modem stack associated with the first SIM, determining whether a next scheduled packet downlink ACK/NACK (PDAN) message transmission on the modem stack associated with the first SIM is missed, and incrementing a PDAN failure counter on the modem stack associated with the first SIM in response to determining that the next scheduled PDAN message transmission on the modem stack associated with the first SIM is missed.

Some embodiments may further include determining whether a value of the PDAN failure counter is at least equal to a threshold, and forcing the shared RF resource to tune back to the first network in response to determining that the value of the PDAN failure counter is at least equal to the threshold. Some embodiments may further include setting the threshold based on a maximum value of at least one counter on the first network. In some embodiments, the at least one counter on the first network may be associated with retransmitting polled downlink data blocks for which no PDAN message is received.

Some embodiments may further include determining whether the tune-away of the shared RF resource has ended in response to determining that the value of the PDAN failure counter is not equal to at least the threshold, and repeating determining whether a next scheduled PDAN message transmission on the modem stack associated with the first SIM is missed in response to determining that the tune-away of the shared RF resource has not ended. In some embodiments, forcing the shared RF resource to tune back to the first network may include cancelling or suspending a communication activity on a modem stack associated with the second SIM. In some embodiments, forcing the shared RF resource to tune back to the first network may include temporarily lowering a priority of the second SIM, in which the priority of the first SIM and the priority of the second SIM are utilized for time sharing arbitration of the shared RF resource.

Some embodiments may further include resetting the PDAN failure counter in response to determining that the next scheduled PDAN message transmission on the modem stack associated with the first SIM is not missed. In some embodiments, identifying scheduled PDAN message transmissions on the modem stack associated with the first SIM may be based on decoded data received from the first network. In some embodiments, identifying scheduled PDAN message transmissions on the modem stack associated with the first SIM may include identifying received data blocks configured with polling indicators from the first network identifying uplink radio blocks indicated by the received data blocks configured with polling indicators. In some embodiments, identifying uplink radio blocks indicated by the received data blocks configured with polling indicators may include identifying uplink radio blocks corresponding to bits in a relative reserved block period (RRBP) field set in headers of the received data blocks that are configured with polling indicators.

Various embodiments further include a wireless communication device having a memory, an RF resource, and a processor coupled to the memory and the RF resource and configured with processor executable instructions to perform operations of the methods described above. Various embodiments include a wireless communication device having means for performing functions of the methods described above. Various embodiments include a non-transitory processor-readable storage medium having stored thereon processor-executable instructions configured to cause a processor of a wireless communication device to perform operations of the methods described above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various embodiments.

FIG. 2 is a block diagram illustrating a wireless communications device according to various embodiments.

FIG. 3 is a system architecture diagram illustrating example protocol layer stacks implemented by a wireless communication device.

FIG. 4 is a process flow diagram illustrating a method for maintaining and improving performance of data communications in a multi-SIM wireless communication device according to various embodiments.

FIG. 5 is a component diagram of an example wireless communication device suitable for use with various embodiments.

FIG. 6 is a component diagram of another example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Various embodiments provide methods and apparatuses for improving performance of communications associated with different SIMs in a wireless communication device configured with a shared RF resource.

In such devices, the shared RF resource is typically used to support both SIMs when both are in idle mode, but one SIM at a time when at least one SIM transitions out of idle mode. In an MSMS device that is using the RF resource to support data communications (i.e., active data session) on a first SIM, the RF resource will still monitor system information from, and maintain a connection with, the serving network of the second SIM, such as by implementing an idle mode that uses discontinuous reception on the second SIM. To perform communication activities associated with the second SIM (e.g., idle mode activities during an “awake” period of the discontinuous reception cycle) the RF resource can tune away from the communication on the first SIM and to the network for the second SIM, followed by tuning back to the communication on the first SIM.

The data link for the active communication on the first SIM communication on the first SIM may be a pair of temporary block flows (TBFs) in the uplink and downlink direction (i.e., concurrent TBFs). The network associated with the first SIM may request acknowledgment of one or more radio block that was sent on the downlink to the MSMS device. In response, the MSMS device may transmit a packet downlink acknowledgment/negative-acknowledgment (ACK/NACK) message back to the network. However, tuning away from the network of the communication on the first SIM may interrupt the active data session. In particular, such interruption may cause the first SIM to miss sending one or more packet downlink ACK/NACK (PDAN) message to the network for data received from the network. The data link for the communication on the first SIM may time out by the network release of the downlink TBF after a certain number of failed PDAN messages. As a result, unless the tune-away to the second network is avoided, throughput for the data communication on the first SIM may be degraded.

Various embodiments may maintain and improve throughput for a data communication session on the network supported by the first SIM, while still allowing for tune-aways to the network supported by the second SIM. Various embodiments provide a counter that keeps track of the consecutive PDAN messages scheduled to be sent on uplink control channels for the first SIM, but for which transmission is missed (e.g., PDAN failure counter). When the number of consecutive missed PDAN message transmissions reaches a predetermined threshold, the MSMS wireless communication device may trigger signaling that forces the shared RF resource to tune back to the network of the data communication on the first SIM. For example, such signaling may involve cancelling or delaying the communication activity associated with the second SIM. In another example, such signaling may involve overriding or lowering the priority of a communication activity on the second SIM.

In various embodiments, the predetermined threshold may be set based on when the network of the data communication on the first SIM will release the data link. In some embodiments, the release of the data link may be based on one or more counter maintained by the network for retransmitting data blocks for which no PDAN is received in an uplink control channel.

The term “wireless communication device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless communication device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms subscription and SIM may also be used as shorthand reference to a communication network associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-SIM wireless communication device,” “multi-SIM wireless communication device,” “dual-SIM wireless communication device,” “dual-SIM dual-standby device,” and “DSDS device” are used interchangeably to describe a wireless communication device that is configured with more than one SIM and allows idle-mode operations to be performed on two networks simultaneously, as well as selective communication on one network while performing idle-mode operations on the other network.

Wireless communication networks are widely deployed to provide various communication services such as voice, packet data, broadcast, messaging, and so on. These wireless networks may be capable of supporting communications for multiple users by sharing the available network resources. Such wireless networks may include CDMA networks, TDMA networks, FDMA networks, Orthogonal FDMA (OFDMA) networks, Single-Carrier FDMA (SC-FDMA) networks, etc. Technologies that may be implemented by such wireless communication networks may include Wireless networks may also utilize various radio technologies such as Wideband CDMA (WCDMA), CDMA2000, Global System for Mobile Communications (GSM), etc. For example, a CDMA network may implement Universal Terrestrial Radio Access (UTRA) (including Wideband CDMA (WCDMA) standards), CDMA2000 (including IS-2000, IS-95 and/or IS-856 standards), etc. In another example, a TDMA network may implement Global System for Mobile Communications (GSM). In another example, an OFDMA network may implement Evolved UTRA (E-UTRA) (including LTE standards), IEEE 802.11 (Wi-Fi), IEEE 802.16 (WiMAX), IEEE 802.20, Flash-OFDM®, etc. These multiple technologies have been adopted in various telecommunication standards to provide a common protocol that enables different wireless communication devices to communicate on a municipal, national, regional, and/or global level.

In some wireless networks, a wireless communication device may have multiple subscriptions to one or more networks (e.g., by employing multiple subscriber identity module (SIM) cards or otherwise). Such a wireless communication device may include, but is not limited to, a dual-SIM dual-standby (DSDS) device. For example, a first subscription may be a first technology standard, such as GSM Enhanced Data rates for GSM Evolution (EDGE) (also referred to as GERAN), while a second subscription may support the same technology standard or a second technology standard, such as WCDMA.

A multi-SIM wireless communication device that supports two or more SIMs may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an “active dual-SIM” wireless communication device allows two SIMs to remain active and accessible to the device. In particular, a type of active dual-SIM wireless communication device may be a “dual-active dual standby” (DSDS) wireless communication device in which two SIMs are configured to share a single transceiver (i.e., RF resource).

In current mobile communications, wireless service carriers have standardized a number of techniques for selecting wireless communications systems and obtaining service therefrom, in accordance with preferences of the subscriber's service provider/carrier. Service providers generally enable subscribers to access a network by providing provisioning information to subscriber devices. For clarity, various embodiments are described below for GSM-type and/or UMTS-type networks, but may be applied to networks using any other radio technology or protocol.

An example GSM network may operate on any of a number of GSM bands (e.g., GSM 900, GSM 850, etc.), each of which cover multiple radio frequency (RF) channels identified by absolute radio frequency channel numbers (ARFCNs). The ARFCNs for various GSM bands are given in 3GPP Technical Specification (TS) 05.05, entitled “Digital cellular telecommunications system (Phase 2+); Radio transmission and reception (Release 1999).” Further, each GSM network typically operates on a specific set of RF channels in a specific GSM band.

In describing various embodiments, the terms “channel,” “frequency,” and “ARFCN” may be used interchangeably and may refer to channels in GSM bands, and/or channels in other network bands (e.g., UTRA absolute radio frequency channel numbers (UARFCNs) for UMTS networks, LTE E-UTRA absolute radio frequency channel numbers (EARFCNs) for LTE networks, etc.).

The SIMs in a multi-SIM wireless communication device may be associated with the same or different public land mobile networks (PLMNs), each of which may have more than one wireless network. Each SIM is generally provisioned by a service provider with a list of preferred PLMNs from which the wireless communication device can receive service (e.g., a home PLMN (HPLMN) and roaming partner PLMNs). In some embodiments, the wireless communication device processor may access non-volatile memory associated with a given one of the SIMs to identify supported radio access technologies, and the corresponding enabled frequency bands (and ARFCNs/UARFCNs/EUARFCNs/channels in each band).

For clarity, references to “first” and “second” SIMs, networks, and subscriptions are arbitrary used only for ease of reference, as at any given time the tune-away operation may be performed from either SIM/network/subscription to the other SIM/network/subscription. Thus, references to “first” and “second” are not intended to refer to a particular radio access technology, SIM, or network, nor to imply an order or priority among the various SIM/network/subscriptions.

While the techniques and embodiments described herein relate to a wireless communication device configured with at least one GSM/GPRS SIM and/or GSM SIM, various embodiments may be extended to subscriptions on other radio access networks (e.g., 1×RTT/CDMA2000, Evolution Data Optimized (EV-DO), LTE, Worldwide Interoperability for Microwave Access (WiMAX), Wi-Fi, etc.). In that regard, the messages, physical and transport channels, radio control states, etc. referred to herein may also be known by other terms in various radio access technologies and standards. Further, the messages, channels, and control states may be associated with different timing in other radio access technologies and standards.

In various embodiments, an RF resource of a MSMS device may be configured to be shared between a plurality of SIMs, but may be employed by default to perform communications on a network enabled by a first SIM, such as a network capable of efficient data communications. As such, a modem stack associated with a second SIM of the device may often be in idle mode communicating only periodically with a second network. Depending on the radio access technology of the second network, such idle mode states may involve implementing a power saving mode that includes a cycle of sleep and awake states. For example, if the second network is a GSM network, during idle mode the modem stack associated with the second SIM may implement discontinuous reception (DRX).

During a wake-up period (i.e., awake state), the timing of which may be set by the second network for a paging group to which the second SIM belongs, the modem stack associated with the second SIM may attempt to use the shared RF resource to monitor a paging channel or an access grant channel of the second network. During the sleep state, the modem stack may power off most processes and components, including the associated RF resource.

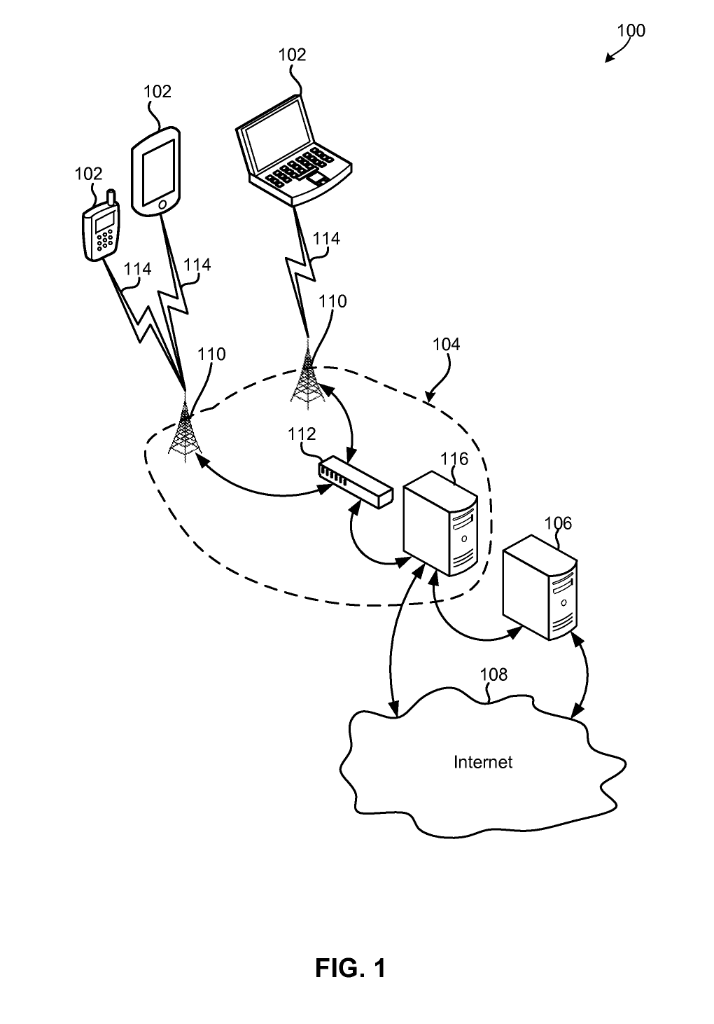

Various embodiments may be implemented within a variety of communication systems, such as the example communication system 100 illustrated in FIG. 1. The communication system 100 may include one or more wireless communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 includes a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a plain old telephone system (POTS) network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, 4G, 3G, CDMA, TDMA, LTE, and/or other communication technologies.

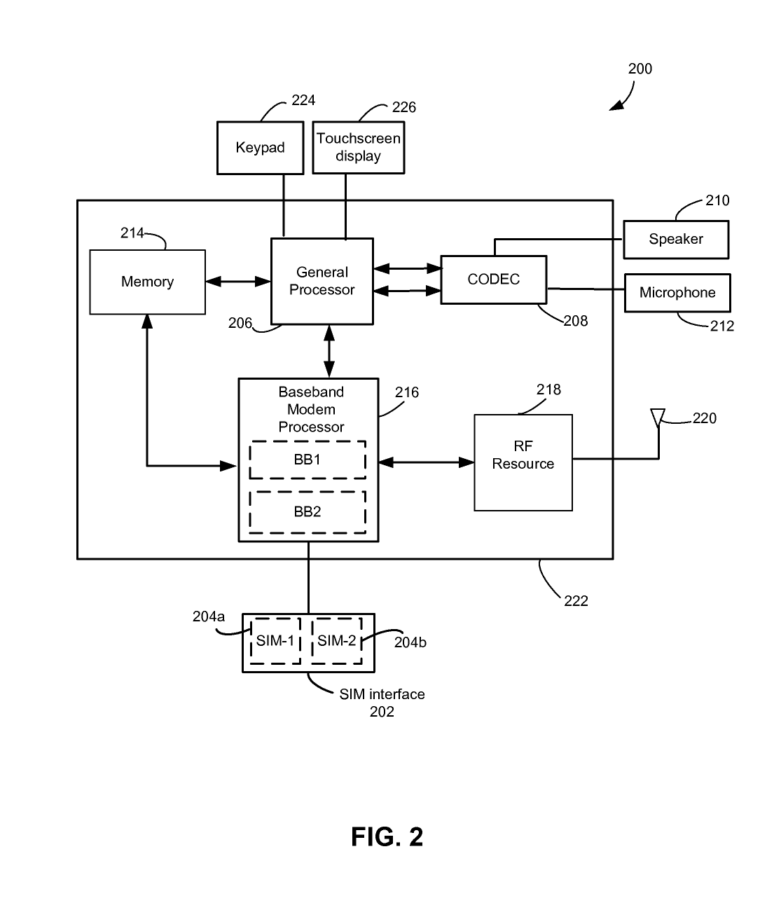

FIG. 2 is a functional block diagram of an example wireless communication device 200 that is suitable for implementing various embodiments. According to various embodiments, the wireless communication device 200 may be similar to one or more of the wireless communication devices 102 described with reference to FIG. 1.

With reference to FIGS. 1-2, in various embodiments, the wireless communication device 200 may be a single-SIM device. In other embodiments, the wireless communication device 200 may be a multi-SIM device, such as a multi-SIM multi-standby (MSMS) device. In some embodiments, the wireless communication device 200 may be a dual-SIM dual-active (DSDA) device. In other embodiments, the wireless communication device 200 may be a dual-SIM dual-standby (DSDS) device.

The wireless communication device 200 may include at least one SIM interface 202, which may receive at least a first SIM (SIM-1) 204a associated with a first subscription and a second SIM (SIM-2) 204b that is associated with a second subscription. In some embodiments, the at least one SIM interface 202 may be implemented as multiple SIM interfaces 202, which may receive at least a second SIM (SIM-2) 204b that is associated with at least a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM 204a, 204b may have a CPU, ROM, RAM, EEPROM and I/O circuits. One or more of the first SIM 204a and the second SIM 204b used in various embodiments may contain user account information, an IMSI a set of SIM application toolkit (SAT) commands and storage space for phone book contacts. One or more of the first SIM 204a and the second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIMs 204a, 204b for identification.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS) processor-executable instructions, as well as user application software executable instructions.

The general-purpose processor 206 and the memory 214 may each be coupled to at least one baseband-modem processor 216. Each SIM 204a, 204b in the wireless communication device 200 may be associated with a baseband-RF resource chain that includes at least one baseband-modem processor 216 and at least one RF resource 218. In some embodiments, the wireless communication device 200 may be a DSDS device, with both SIMs 204a, 204b sharing a single baseband-RF resource chain that includes the baseband-modem processor 216 and the RF resource 218. In some embodiments, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and the RF resource 218 may perform transmit/receive functions for the wireless services associated with each SIM 204a, 204b of the wireless communication device 200. The RF resource 218 may implement separate transmit and receive functionalities or may include a transceiver that combines transmitter and receiver functions.

In particular embodiments, the general-purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the wireless communication device 200 to enable communication between them, as is known in the art.

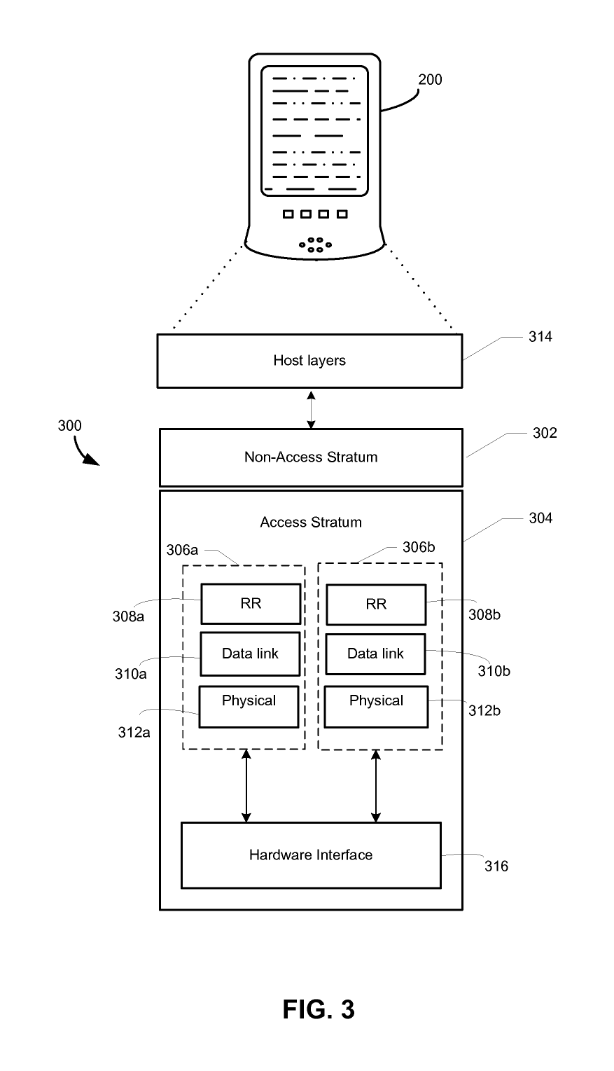

As illustrated in FIG. 3, a wireless communication device, such as the wireless communication device 102, 200 in FIGS. 1-2, may have a layered software architecture 300 to communicate over access networks associated with SIMs. With reference to FIGS. 1-3, the software architecture 300 may be distributed among one or more processors, such as the baseband-modem processor 216. The software architecture 300 may also include a Non-Access Stratum (NAS) 302 and an Access Stratum (AS) 304. The NAS 302 may include functions and protocols to support traffic and signaling between SIMs of the wireless communication device 200 (e.g., first SIM/SIM-1 204a, second SIM/SIM-2 204b) and their respective core networks. The AS 304 may include functions and protocols that support communication between the SIMs (e.g., first SIM 204a, second SIM 204b) and entities of their respective access networks (such as a mobile switching center (MSC) if in a GSM network).

In the multi-SIM wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications. Each protocol stack 306a, 306b may respectively include radio resource management (RR) layers 308a, 308b. The RR layers 308a, 308b may be part of Layer 3 of a GSM signaling protocol and may oversee the establishment of a link between the wireless communication device 200 and associated access networks. In various embodiments, the NAS 302 and RR layers 308a, 308b may perform the various functions to search for wireless networks and to establish, maintain and terminate calls.

In some embodiments, each RR layer 308a, 308b may be one of a number of sub-layers of Layer 3. Other sub-layers may include, for example,., mobility management (MM) sublayers to manage the location updating and registration procedures, and connection management (CM) sub-layers (not shown) that route calls, select a service type, prioritize data, perform QoS functions, etc.

Residing below the RR layers 308a, 308b, the protocol stacks 306a, 306b may also respectively include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure the data has been successfully received. In some embodiments, each data link layer 310a, 310b may contain various sub-layers. For example, a packet data convergence protocol (PDCP) sublayer may provide multiplexing between difference radio bearers and logical channels. The PDCP sublayer may provide header compression for upper layer data packets to reduce radio transmission overhead, security by ciphering the data packets, and handover support between cell sites. Below the PDCP sublayer, a radio link control (RLC) sublayer may provide segmentation and reassembly of upper layer data packets, retransmission of lost data packets, and reordering of data packets to compensate for out-of-order reception due to hybrid automatic repeat request (HARQ).

Below the RLC sublayer, a media access control (MAC) sublayer may provide multiplexing between logical and transport channels. The MAC sublayer may also be responsible for allocating various radio resources (e.g., radio blocks) in one cell among various devices, and HARQ operations. Residing below the data link layers 310a, 310b, the protocol stacks 306a, 306b may also respectively include physical layers 312a, 312b, which may establish connections over the air interface and manage network resources for the wireless communication device 200.

While the protocol stacks 306a, 306b provide functions to transmit data through physical media, the software architecture 300 may further include at least one host layer 314 to provide data transfer services to various applications in the wireless communication device 200. In some embodiments, application-specific functions provided by the at least one host layer 314 may provide an interface between the protocol stacks 306a, 306b and the general-purpose processor 206. In alternative embodiments, the protocol stacks 306a, 306b may each include one or more higher logical layers (e.g., transport, session, presentation, application, etc.) that provide host layer functions. In some embodiments, the software architecture 300 may further include in the AS 304 a hardware interface 316 between the physical layers 312a, 312b and the communication hardware (e.g., one or more RF resource).

In various embodiments, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

Although described below with reference to GSM-type communication layers, the modem stacks in various embodiments may support any of a variety of current and/or future protocols for wireless communications. For examples, the modem stacks in various embodiments may support networks using other radio access technologies described in 3GPP standards (e.g., UMTS, Long Term Evolution (LTE), etc.), 3GPP2 standards (e.g., 1×RTT/CDMA2000, Evolved Data Optimized (EV-DO), Ultra Mobile Broadband (UMB), etc.) and/or IEEE standards Worldwide Interoperability for Microwave Access (WiMAX), Wi-Fi, etc.).

In a conventional GSM system, a wireless communication device may attempt to be assigned a dedicated channel resource by sending a resource request message to a base station of a network. For example, a wireless communication device (or modem stack associated with a SIM in the wireless communication device) may initiate a communication to another wireless communication device (e.g., a mobile terminating call, data session for transmitting and receiving packets, etc.) by requesting a connection to the network associated with that SIM.

The GSM standard employs a multiple access scheme that defines how simultaneous communication can occur between different wireless communication devices and base stations. Within each cell, a combination of FDMA and time division multiple access (TDMA) techniques are employed by the standard. Specifically, the available spectrum is divided into carrier frequencies of 200 kHz bandwidth, with pairs of carriers that are 45 MHz apart from each other identified by an absolute radio-frequency channel number (ARFCN). Each pair of carrier frequencies (one uplink, one downlink) is also divided into eight time slots (e.g., TS0 through TS7) using TDMA such that eight consecutive time slots form one TDMA frame, lasting approximately 4.615 ms. In this manner individual physical channels may be formed, each of which correspond to a particular carrier frequency and time slot number.

Logical channels may be mapped to the physical channels, and categorized by the information carried. Specifically, control channels may carry signaling or synchronization data to or from group including a particular wireless communication device (or modem stack associated with a SIM of the device). In various embodiments, a wireless communication device may be assigned a time slot in which the group including the device may receive messages on TDMA frames carrying common control channels. Therefore, the wireless communication device may be configured to receive and decode only the bursts within that timeslot, which is repeated after the other seven time slots of the TDMA frame (e.g., totally around 4.03 ms).

Mechanisms for establishing and assigning a dedicated channel for communications in GSM are radio resource establishment procedures specified in Section 3.3 of 3GPP TS 04.08 entitled “Digital cellular telecommunications system (Phase 2+); Mobile radio interface layer 3 specification (Release 1999).” The General packet radio service (GPRS) is a packet oriented mobile data service in GSM, for which the radio resource establishment procedures are specified in 3GPP TS 44.160 “General Packet Radio Service (GPRS); Mobile Station (MS)—Base Station System (BSS) interface; Radio Link Control/Medium Access Control (RLC/MAC) protocol for Iu mode (Release 10).”

GPRS uses the same modulation and frame structure that is employed by GSM, and in this way it is an evolution of the GSM standard. Slots can be assigned dynamically by the base station controller (BSC) to GPRS calls dependent upon the demand, the remaining ones being used for GSM traffic. The packet data channel (PDCH) used in GPRS use the same overall slot structure as that used within GSM, having the same power profile and timing advance attributes to overcome the different signal travel times to a base station that depend on dependent on distance of the wireless communication device to the base station.

In data communications in GPRS, temporary radio resources may be allocated to a wireless communication device (or modem stack associated with a SIM of a multi-SIM wireless communication device) for the duration of a data transfer. In particular, such temporary radio resource may be a temporary block flow (TBF) that supports the unidirectional transfer of protocol data units on PDCHs. In a conventional data communication, a network may establish both a downlink TBF and an uplink TBF. As described, the MAC sublayer typically manages all signaling necessary for establishing and releasing TBFs, as well as mapping and multiplexing of signaling and data onto the different logical subchannels.

The RLC sublayer typically manages data transfer management during the TBF, providing an acknowledged mode allowing selective retransmission of radio blocks. In the data communication session, information transmitted over four consecutive bursts on four TDMA frames of a given PDCH is referred to as a radio block, which may be used to carry data and RLC/MAC signaling. For example, an RLC data block may be mapped onto one radio block on a packet data traffic channel (PDTCH) in the uplink or downlink direction. Further, an RLC/MAC control block may be mapped onto one radio block on a control channel, such as a packet associated control channel (PACCH) or a packet broadcast control channel (PBCCH). In particular, the associated control channel (ACCH) may be used for uplink and downlink control signaling during an active communication, and may carry information such as channel assignments, power control messages and acknowledgment or negative acknowledgment messages for received data.

In order to initiate a downlink data communication to a wireless communication device (or modem stack associated with a SIM of a multi-SIM wireless communication device), the network may send a packet downlink assignment message on a packet access grant channel (PAGCH) if the device is in a GPRS ready state. Specifically, in the GPRS ready state, the network is aware of cell location as a result of the successful mobility management procedure, and the wireless communication device may activate and deactivate receive packet data protocol (PDP) contexts, and send or receive PDP protocol data units (PDUs).

If the wireless communication device is in a GPRS standby state, the network may initiate a packet paging procedure by sending one or more packet paging request message on the Packet Paging Channel (PPCH) in all cells of the last stored routing area for the wireless communication device. As a result of the packet paging procedure, the wireless communication device enters the GPRS ready state.

Each TBF may be assigned a temporary flow identifier (TFI) by the network, and each uplink and downlink radio block may include a particular TFI. In this manner, the TFI may be used to differentiate TBFs sharing the same PDCHs in one direction to enable multiplexing of blocks assigned, for example, to different devices. In case of concurrent TBFs, a different TFI is used to identify each of the uplink and downlink TBFs.

After reception of the packet downlink assignment message, the wireless communication device may receive data by listening to (i.e., monitoring) one or more assigned PDCH to detect RLC data blocks that include a TFI for a downlink TBF on the device. The frequency and timing of acknowledgments for downlink data are controlled by the network through a polling mechanism. For example, the polling mechanism may involve setting a supplementary/polling (S/P) bit in the MAC header of the radio block to which the downlink RLC data block is mapped. Based on this bit, the wireless communication device is requested to send a packet downlink ACK/NACK (PDAN) message to the network in an uplink control channel. Further, the wireless communication device is instructed as to the particular uplink radio blocks for sending such PDAN message by a reserved relative block period (RRBP) field also in the header of the downlink RLC data block. Therefore, upon receiving an RLC data block that is addressed to a TBF assigned to the device and in which the S/P bit is set, the wireless communication device may transmit a PDAN message in the uplink radio block specified by bits in the RRBP field on a PACCH.

After a downlink TBF is established, the network may start a counter (N3105), which is reset when the network receives a PDAN message on the uplink radio block corresponding to the RRBP set in the downlink TBF. The network may increment the counter N3105 for each downlink RLC data block allocated to that TBF with polling, but for which no PDAN message was received. The network may also resend such downlink RLC data blocks with the RRBP set.

If the N3105 counter reaches a preset maximum N3105 value, the network may notify a link failure to the RR sublayer, and may trigger an abnormal release of the downlink TBF. In various embodiments, the maximum N3105 value may be set by the network in the range of 3-10. For example, setting the maximum N3105 value in the lower part of the range may decrease the tolerance of the network to downlink errors, and increase the probability of abnormal downlink TBF releases. Setting the maximum N3105 value to a higher value, the network may still assign radio resources to the wireless communication device even when a corresponding PDAN message is not received. In other embodiments, any suitable range may be implemented.

As discussed, in a MSMS wireless communication device configured with a RF resource shared by all SIMs, modem stacks associated with multiple SIMs may be in idle mode simultaneously, but communication may be enabled on only one modem stack at a time. During an active data communication on a modem stack associated with a first SIM, the RF resource may be tuned to a first network (e.g., a GSM/GPRS network) for sending and/or receiving data packets. A request for access to the RF resource may be based on a requested or required communication activity on a modem stack associated with the second SIM. Conventionally, the active communication on the modem stack associated with the first SIM may be paused to allow the second SIM to tune away to a second network. Such tune-away to a second network may be for receiving bursts on data downlink control channels (e.g., PPCH, PAGCH, AGCH, etc.), for mobility management procedures, etc., depending on the second network and prioritization between the SIMs.

Due to the tune-aways to the second network, the modem stack associated with the first SIM may fail to transmit a number of important uplink RLC/MAC control blocks, including PDAN messages for downlink data polled by the first network. That is, reserved radio blocks indicated in decoded data that the wireless communication device received in one or more TBFs from the first network may be missed in one or more uplink PACCH while the shared RF resource is tuned to the second network. Such decoded data may include a number of retransmissions, from the first network, of downlink RLC data blocks for which no PDAN message was originally received. As a result, the first network may reach the maximum N3105 value for one or more TBF, causing a radio link failure, and degrading performance/throughput for the data communication on the first SIM.

In various embodiments, the impact of tune-away periods of the shared RF resource on the data communications on the first SIM may be mitigated by improving tune-away management. In various embodiments, the wireless communication device may maintain a PDAN failure counter to track the consecutive missed PDAN message transmissions. Such missed transmissions may be tracked based on uplink PACCHs in the first network, and the reserved radio blocks in which PDAN messages should have been sent. As described, the reserved radio block in which a PDAN message should be sent may be identified based on the MAC header of the downlink RLC data block polled by the network. Therefore, using the scheduled PACCHs in the first network, each PDAN message transmission opportunity may be identified. In various embodiments, a PDAN message transmission opportunity may be referred to as a scheduled PDAN message transmission.

The wireless communication device may also monitor RF resource activity, including uplink transmissions. By comparing the scheduled PDAN message transmissions to actual communication activity on the RF resource, each scheduled PDAN message transmission may be identified as missed (i.e., no PDAN message sent) or completed (i.e., PDAN message sent).

The wireless communication device may set a predetermined threshold value for the PDAN failure counter based, for example, on the maximum N3105 value for the first network. For each scheduled PDAN message transmission that is missed on the first SIM modem stack, the PDAN failure counter may be incremented by one. For each scheduled PDAN message transmission that is completed on the first modem stack, the PDAN failure counter may be reset, such that the PDAN failure counter only tracks consecutive missed PDAN message transmission opportunities.

When the number of consecutive missed PDAN message transmission opportunities (i.e., scheduled PDAN message transmissions that are missed) reaches the threshold, the wireless communication device may force the shared RF resource to tune back to the first network. In this manner, the tune-away to the second network may be allowed to take place normally until a link failure is likely to occur on the first network (i.e., release of the downlink TBF) that would impact data throughput by releasing the downlink TBF. In order to force the shared RF resource to tune back to the first network, in some embodiments, the communication activity associated with the second SIM may be cancelled, suspended, or delayed. In some embodiments, the wireless communication device may override the signaling that indicates a requested or required communication activity. In some embodiments, the wireless communication device may temporarily lower a priority associated with the second SIM (or raise a priority associated with the first SIM) in implementations in which such priorities are normally used for arbitrating time sharing of the shared RF resource.

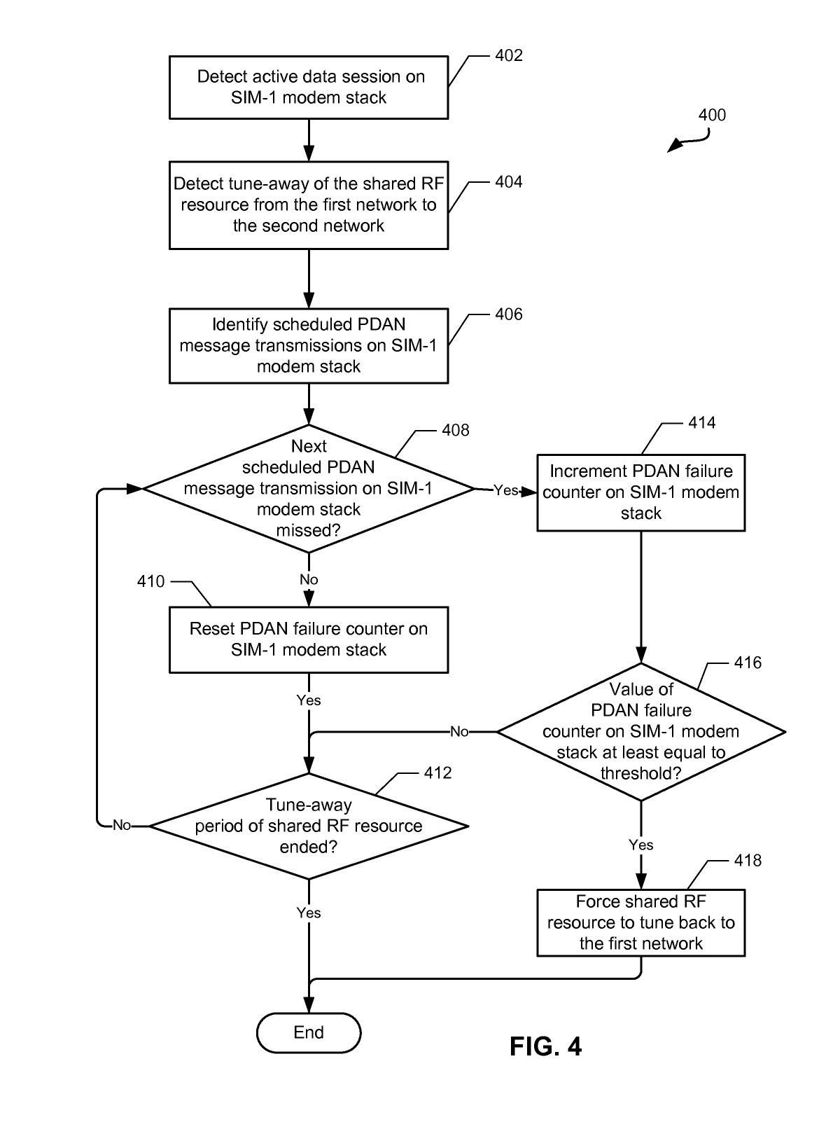

FIG. 4 illustrates a method 400 for improving throughput on an active data communication in a first network supported by a first SIM by managing tune-aways to a second network supported by a second SIM of a multi-SIM multi-standby wireless communication device according to various embodiments. With reference to FIGS. 1-4, the multi-SIM multi-standby device (e.g., 102, 200) may be configured with a single shared RF resource (e.g., 218). In various embodiments, the operations of the method 400 may be implemented by one or more processors of the wireless communication device, such as a general-purpose processor (e.g., 206) and/or baseband-modem processor (e.g., 216). In various embodiments, the operations of the method 400 may be implemented by a separate controller (not shown) that may be coupled to memory (e.g., 214) and to the one or more processors.

In block 402, the wireless communication device processor may detect that a modem stack associated with a first SIM (“SIM-1”) is participating in an active data session on a first network supported by the first SIM. In some embodiments, the data session may involve sending and/or receiving data packets to the first network using one or more of a variety of radio access technologies (e.g., WCDMA/UMTS, EDGE, LTE, etc.) In block 404, the wireless communication device processor may detect a

tune-away of the shared RF resource (e.g., 218) from the first network to a second network supported by the second SIM. In some situations, the modem stack associated with the second SIM may be camped in idle mode on the second network supported by the second SIM. The tune-away to the second network may be used to monitor a paging channel in a timeslot assigned to a paging group of the second SIM, and may be performed periodically according to a DRX cycle established by the second network.

In some embodiments, the tune-away to the second network may be to monitor an access grant channel in the assigned timeslot following a request to the second network on the random access channel (RACH) using the shared RF resource. Such a request may be, for example, a result of receiving input indicating a desire to start a mobile originating voice call on the second network (e.g., keypad input from the user, etc.), or to start an uplink packet data and/or a short message service (SMS) text communication to the second network. In some embodiments, the tune-away to the second network may be required for mobility management, such as a handover to a different cell or system.

In block 406, the wireless communication device processor may identify scheduled PDAN message transmissions on the modem stack associated with the first SIM. As described, scheduled PDAN message transmissions (i.e., PDAN message transmission opportunities) may be identified based on the uplink logical channels of the first network, and the decoded downlink data received from the first network. In particular, the decoded downlink data received from the first network may include the uplink radio block identified in the MAC header of each downlink RLC data block that includes a polling indicator and that was received from the first network. In some embodiments, the modem stack associated with the first SIM may simultaneously have multiple concurrent TBFs, and therefore may have multiple RLC data blocks that were received on different PDCHs from the first network.

In determination block 408, the wireless communication device processor may determine whether a next scheduled PDAN message transmission on the modem stack associated with the first SIM is missed. That is, the wireless communication device processor may determine whether a PDAN message is actually transmitted to the first network during an identified PDAN message transmission opportunity (i.e., from block 406).

In response to determining that the next scheduled PDAN message transmission on the modem stack associated with the first SIM was not missed (i.e., determination block 408=“No”), the wireless communication device processor may reset a PDAN failure counter for the first SIM, in block 410. That is, if the processor determines that the next scheduled PDAN message transmission was not missed, that scheduled PDAN message transmission may be identified as completed (i.e., a PDAN message transmitted to the first network).

In determination block 412, the wireless communication device processor may determine whether the tune-away period of the shared RF resource has ended, such that the RF resource is already tuned back to the first network. In some embodiments, the end of the tune-away period may be the cause for the completion of the next scheduled PDAN message transmission that was determined in block 408. In response to determining that the tune-away period of the shared RF resource has ended (i.e., determination block 412=“Yes”), the method 400 may end.

In response to determining that the tune-away period of the shared RF resource has not ended (i.e., determination block 412=“No”), the wireless communication device processor may again determine whether a next scheduled PDAN message transmission on the modem stack associated with the first SIM is missed, in determination block 408. In some embodiments, completion of the next scheduled PDAN message transmission that was determined in block 408 may occur even if the tune-away period is not ended, which may in turn cause the wireless device processor to again determine whether a next scheduled PDAN message transmission on the modem stack associated with the first SIM is missed in determination block 408. For example, such completion may be the result of the first and second SIMs supporting the same or overlapping networks, use of diversity antennas and/or hybrid mode in tuning away to the second network, etc.

In response to determining that the next scheduled PDAN message transmission on the modem stack associated with the first SIM was missed (i.e., determination bock 408=“Yes”), the wireless communication device processor may increment a PDAN failure counter on the modem stack associated with the first SIM, in block 414. That is, if no PDAN message was sent to the first network in the next PDAN message transmission opportunity, the wireless communication device processor may increase a count of the number of consecutive missed PDAN message transmission opportunities.

In determination block 416, the wireless communication device processor may determine whether the value of the PDAN failure counter on the modem stack associated with the first SIM is at least equal to a threshold. In some embodiments, the threshold may be set by the wireless communication device processor based on a maximum value of a network counter that may signal a radio link failure associated with releasing a TBF (e.g., preset maximum N3105 value). As described, more than one pair of concurrent TBFs may be assigned to the first SIM for active communications in the first network. Therefore, the PDAN failure counter on the modem stack associated with the first SIM may be configured to track scheduled PDAN message transmissions that are missed in any downlink TBF assigned to the first SIM, and the threshold may be based on a calculation using a combination of maximum N3105 values.

In response to determining that the value of the PDAN failure counter on the modem stack associated with the first SIM is at least equal to the threshold (i.e., determination block 416=“Yes”), the wireless communication device processor may force the shared RF resource to tune back to the first network, in block 418, after which the method 400 may end. That is, the wireless communication device processor may trigger termination of the tune-away period on the shared RF resource in order to avoid a potential abnormal release of one or more downlink TBF by the first network. As described, in some embodiments, forcing the shared RF resource to tune back to the first network may involve signaling that cancels or delays a communication activity associated with the second SIM. In some embodiments, forcing the shared RF resource to tune back to the first network may involve overriding or lowering the priority of the communication activity on the second SIM.

In response to determining that the value of the PDAN failure counter on the modem stack associated with the first SIM is not at least equal to the threshold (i.e., determination block 416=“No”), the wireless communication device processor may determine whether the tune-away period of the shared RF resource has ended, in determination block 412.

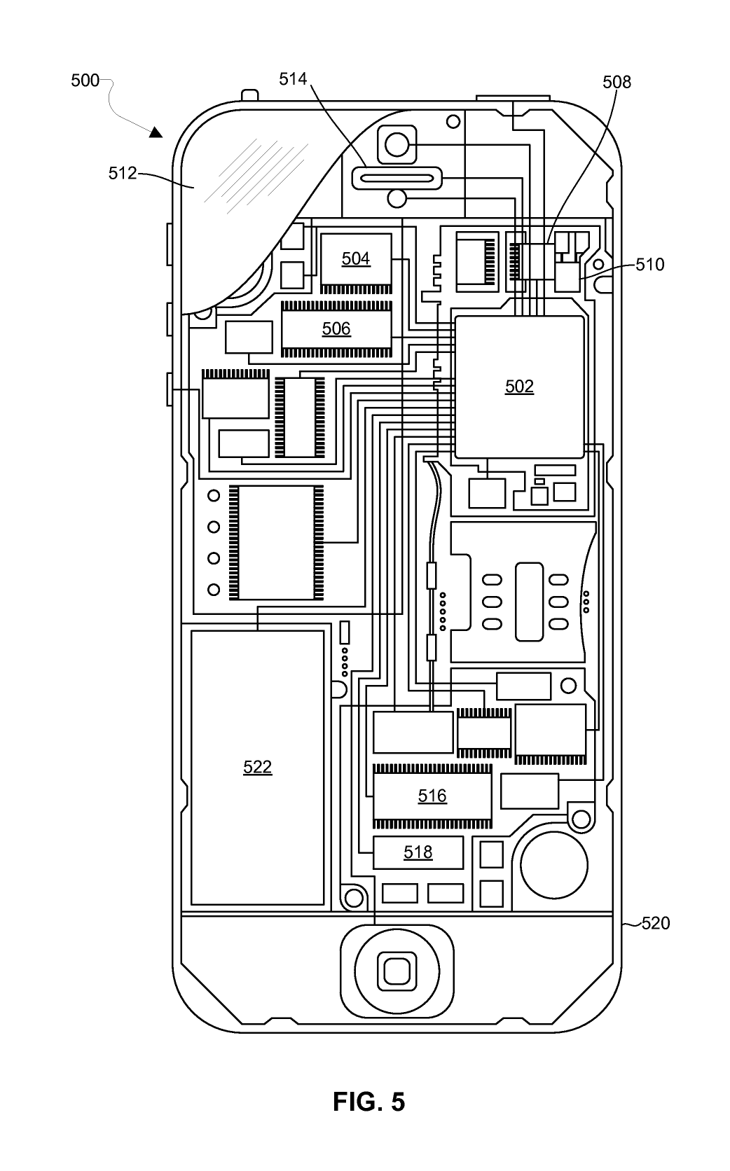

Various embodiments (including, but not limited to, the embodiments discussed with reference to FIG. 4), may be implemented in any of a variety of wireless communication devices, an example of which is illustrated in FIG. 5. For example, with reference to FIGS. 1-5, a wireless communication device 500 (which may correspond, for example, the wireless communication devices 102,200 in FIGS. 1-2) may include a processor 502 coupled to a touchscreen controller 504 and an internal memory 506. The processor 502 may be one or more multicore integrated circuits (ICs) designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless communication device 500 may have one or more radio signal transceivers 508 (e.g., Peanut®, Bluetooth®, ZigBee®, Wi-Fi, RF radio) and antennae 510, for sending and receiving, coupled to each other and/or to the processor 502. The transceivers 508 and antennas 510 may be used with circuitry (e.g., 502, 504, 512) in various embodiments to implement the various wireless transmission protocol stacks and interfaces. The wireless communication device 500 may include a cellular network wireless modem chip 516 that enables communication via a cellular network and is coupled to the processor.

The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to the peripheral device connection port to receive a charging current from a source external to the wireless communication device 500.

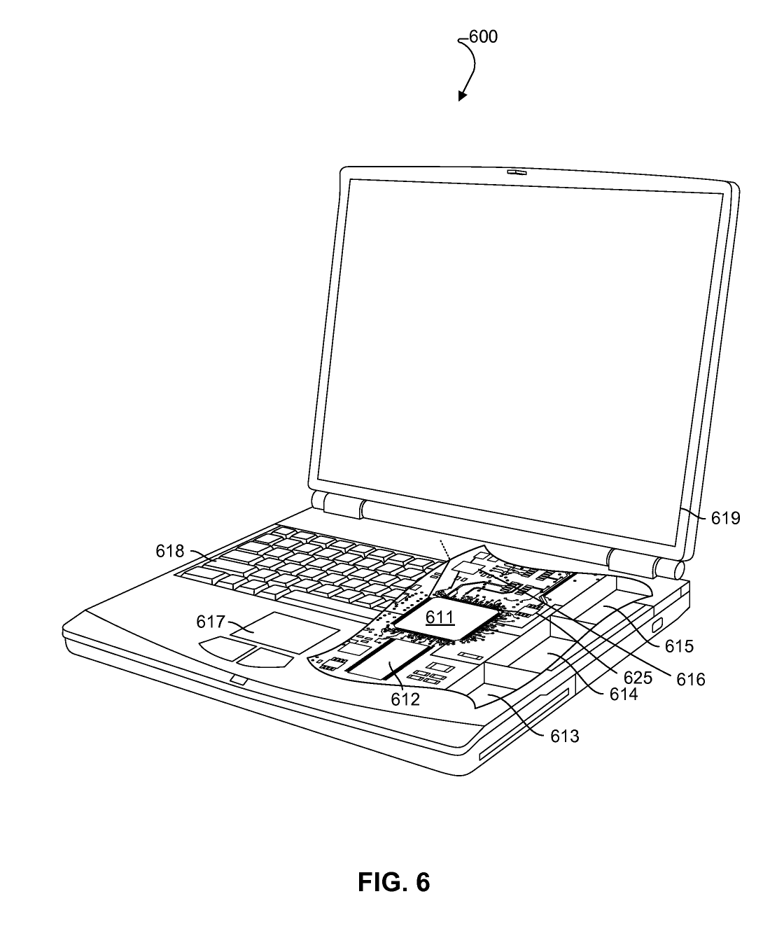

Various embodiments (including, but not limited to, the embodiments discussed with reference to FIG. 4), may also be implemented within a variety of personal computing devices, an example 600 of which is illustrated in FIG. 6. With reference to FIGS. 1-6, the laptop computer 600 (which may correspond, for example, to the wireless communication devices 102, 200 in FIGS. 1-3) may include a touchpad touch surface 617 that serves as the computer's pointing device, and thus may receive drag, scroll, and flick gestures similar to those implemented on wireless computing devices equipped with a touchscreen display as described. A laptop computer 600 will typically include a processor 611 coupled to volatile memory 612 and a large capacity nonvolatile memory, such as a disk drive 613 of Flash memory. The computer 600 may also include a floppy disc drive 614 and a compact disc (CD) drive 615 coupled to the processor 611. The computer 600 may also include a number of connector ports coupled to the processor 611 for establishing data connections or receiving external memory devices, such as a universal serial bus (USB) or FireWire® connector sockets, or other network connection circuits for coupling the processor 611 to a network. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

With reference to FIGS. 1-6, the processors 502 and 611 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm operations described in connection with various embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiment, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing a tune-away on a multi-subscriber identity module (SIM) wireless communication device having at least a first SIM and a second SIM associated with a shared radio frequency (RF) resource, the method comprising:
detecting an active data communication in a first network on a modem stack associated with the first SIM;
detecting a tune-away of the shared RF resource from the first network to a second network supported by the second SIM;
identifying scheduled packet downlink acknowledgment/negative acknowledgment (ACK/NACK) message transmissions on the modem stack associated with the first SIM;
determining whether a next scheduled packet downlink ACK/NACK (PDAN) message transmission on the modem stack associated with the first SIM is missed; and
incrementing a PDAN failure counter on the modem stack associated with the first SIM in response to determining that the next scheduled PDAN message transmission on the modem stack associated with the first SIM is missed.

2. The method of claim 1, further comprising:
determining whether a value of the PDAN failure counter is at least equal to a threshold; and
forcing the shared RF resource to tune back to the first network in response to determining that the value of the PDAN failure counter is at least equal to the threshold.

3. The method of claim 2, further comprising:
setting the threshold based on a maximum value of at least one counter on the first network that is associated with retransmitting polled downlink data blocks for which no PDAN message is received.

4. The method of claim 2, further comprising:
determining whether the tune-away of the shared RF resource has ended in response to determining that the value of the PDAN failure counter is not at least equal to the threshold; and
repeating determining whether a next scheduled PDAN message transmission on the modem stack associated with the first SIM is missed in response to determining that the tune-away of the shared RF resource has not ended.

5. The method of claim 2, wherein forcing the shared RF resource to tune back to the first network comprises:
cancelling or suspending a communication activity on a modem stack associated with the second SIM.

6. The method of claim 2, wherein forcing the shared RF resource to tune back to the first network comprises:
temporarily lowering a priority of the second SIM;
wherein a priority of the first SIM and the priority of the second SIM are utilized for time sharing arbitration of the shared RF resource.

7. The method of claim 1, further comprising:
resetting the PDAN failure counter in response to determining that the next scheduled PDAN message transmission on the modem stack associated with the first SIM is not missed.

8. The method of claim 1, wherein identifying scheduled PDAN message transmissions on the modem stack associated with the first SIM is based on decoded data received from the first network.

9. The method of claim 8, wherein identifying scheduled PDAN message transmissions on the modem stack associated with the first SIM comprises:
identifying received data blocks configured with polling indicators from the first network; and
identifying uplink radio blocks indicated by the received data blocks.

10. The method of claim 9, wherein identifying uplink radio blocks indicated by the received data blocks comprises:
identifying uplink radio blocks corresponding to bits in a relative reserved block period (RRBP) field set in headers of the received data blocks.

11. A wireless communication device, comprising:
a memory;
a radio frequency (RF) resource; and
a processor coupled to the memory and the RF resource, configured to connect to at least a first subscriber identity module (SIM) and a second SIM, and configured with processor-executable instructions to:
detect an active data communication in a first network on a modem stack associated with the first SIM;
detect a tune-away of the RF resource from the first network to a second network supported by the second SIM;
identify scheduled packet downlink acknowledgment/negative acknowledgment (ACK/NACK) message transmissions on the modem stack associated with the first SIM;
determine whether a next scheduled packet downlink ACK/NACK (PDAN) message transmission on the modem stack associated with the first SIM is missed; and
increment a PDAN failure counter on the modem stack associated with the first SIM in response to determining that the next scheduled PDAN message transmission on the modem stack associated with the first SIM is missed.

12. The wireless communication device of claim 11, wherein the processor is further configured with processor-executable instructions to:
determine whether a value of the PDAN failure counter is at least equal to a threshold; and
force the RF resource to tune back to the first network in response to determining that the value of the PDAN failure counter is at least equal to the threshold.

13. The wireless communication device of claim 12, wherein the processor is further configured with processor-executable instructions to:
set the preset based on a maximum value of at least one counter on the first network that is associated with retransmitting polled downlink data blocks for which no PDAN message is received.

14. The wireless communication device of claim 12, wherein the processor is further configured with processor-executable instructions to:
determine whether the tune-away of the RF resource has ended in response to determining that the value of the PDAN failure counter is not at least equal to the threshold; and
repeat determining whether a next scheduled PDAN message transmission on the modem stack associated with the first SIM is missed in response to determining that the tune-away of the RF resource has not ended.

15. The wireless communication device of claim 12, wherein the processor is further configured with processor-executable instructions to force the RF resource to tune back to the first network by cancelling or suspending a communication activity on a modem stack associated with the second SIM.

16. The wireless communication device of claim 12, wherein the processor is further configured with processor-executable instructions to force the RF resource to tune back to the first network by temporarily lowering a priority of the second SIM, wherein a priority of the first SIM and the priority of the second SIM are utilized for time sharing arbitration of the RF resource.

17. The wireless communication device of claim 11, wherein the processor is further configured with processor-executable instructions to:
reset the PDAN failure counter in response to determining that the next scheduled PDAN message transmission on the modem stack associated with the first SIM is not missed.

18. The wireless communication device of claim 11, wherein the processor is further configured with processor-executable instructions to identify scheduled PDAN message transmissions on the modem stack associated with the first SIM based on decoded data received from the first network.

19. The wireless communication device of claim 18, wherein the processor is further configured with processor-executable instructions to identify scheduled PDAN message transmissions on the modem stack associated with the first SIM by:
identifying received data blocks configured with polling indicators from the first network; and
identifying uplink radio blocks indicated by the received data blocks.

20. The wireless communication device of claim 19, wherein the processor is further configured with processor-executable instructions to identify uplink radio blocks indicated by the received data blocks by:
identifying uplink radio blocks corresponding to bits in a relative reserved block period (RRBP) field set in headers of the received data blocks.

21. A wireless communication device, comprising:
a radio frequency (RF) resource;
means for detecting an active data communication in a first network on a modem stack associated with a first subscriber identity module (SIM);
means for detecting a tune-away of the RF resource from the first network to a second network supported by a second SIM;
means for identifying scheduled packet downlink acknowledgment/negative acknowledgment (ACK/NACK) message transmissions on the modem stack associated with the first SIM;
means for determining whether a next scheduled packet downlink ACK/NACK (PDAN) message transmission on the modem stack associated with the first SIM is missed; and
means for incrementing a PDAN failure counter on the modem stack associated with the first SIM in response to determining that the next scheduled PDAN message transmission on the modem stack associated with the first SIM is missed.

22. A non-transitory processor-readable storage medium having stored thereon processor-executable instructions configured to cause a processor of a wireless communication device to perform operations comprising:
detecting an active data communication in a first network on a modem stack associated with a first subscriber identity module (SIM);
detecting a tune-away of a radio frequency (RF) resource from the first network to a second network supported by a second SIM;
identifying scheduled packet downlink acknowledgment/negative acknowledgment (ACK/NACK) message transmissions on the modem stack associated with the first SIM based on decoded data received from the first network;
determining whether a next scheduled packet downlink ACK/NACK (PDAN) message transmission on the modem stack associated with the first SIM is missed; and
incrementing a PDAN failure counter on the modem stack associated with the first SIM in response to determining that the next scheduled PDAN message transmission on the modem stack associated with the first SIM is missed.

23. The non-transitory processor-readable storage medium of claim 22, wherein the stored processor-executable instructions are configured to cause the processor of the wireless communication device to perform operations further comprising:
determining whether a value of the PDAN failure counter is at least equal to a threshold; and
forcing the shared RF resource to tune back to the first network in response to determining that the value of the PDAN failure counter is at least equal to the threshold.

24. The non-transitory processor-readable storage medium of claim 23, wherein the stored processor-executable instructions are configured to cause the processor of the wireless communication device to perform operations further comprising:
setting the threshold based on a maximum value of at least one counter on the first network that is associated with retransmitting polled downlink data blocks for which no PDAN message is received.

25. The non-transitory processor-readable storage medium of claim 23, wherein the stored processor-executable instructions are configured to cause the processor of the wireless communication device to perform operations further comprising:
determining whether the tune-away of the shared RF resource has ended in response to determining that the value of the PDAN failure counter is not at least equal to the threshold; and
repeating determining whether a next scheduled PDAN message transmission on the modem stack associated with the first SIM is missed in response to determining that the tune-away of the shared RF resource has not ended.

26. The non-transitory processor-readable storage medium of claim 23, wherein the stored processor-executable instructions are configured to cause the processor of the wireless communication device to perform operations such that:
forcing the shared RF resource to tune back to the first network comprises cancelling or suspending a communication activity on the modem stack associated with the second SIM.

27. The non-transitory processor-readable storage medium of claim 22, wherein the stored processor-executable instructions are configured to cause the processor of the wireless communication device to perform operations further comprising:
resetting the PDAN failure counter in response to determining that the next scheduled PDAN message transmission on the modem stack associated with the first SIM is not missed.
